(19) United States
(12) Patent Application Publication
(10) Pub. No.: US 2007/0132324 A1
(43) Pub. Date: Jun. 14, 2007

(54) Rotary electric machine including a brake engaging two opposite braking surfaces

(75) Inventor: Eric Coupart, Angouleme (FR)

Correspondence Address: OLIFF & BERRIDGE, PLC, P.O. BOX 19928, ALEXANDRIA, VA, 22320, US

(73) Assignee: MOTEURS LEROY-SOMER, ANGOULEME (FR)

(21) Appl. No.: 11/633,051

(22) Filed: Dec. 4, 2006

(30) Foreign Application Priority Data
Dec. 9, 2005 (FR) 05 53824

(51) Int. Cl. H02K 7/00; H02K 7/10

(52) U.S. Cl. 310/67 R; 310/77; 310/93; 310/261

(57) ABSTRACT

The present invention relates to a rotary electric machine comprising: a stator; a rotor having an axis of rotation, and comprising a tubular end wall defining two opposite braking surfaces; and at least one electromagnetic brake configured for bear simultaneously in a braking configuration against the braking surfaces.

### FIELD OF THE INVENTION

The present invention relates to a rotary electric machine, and more particularly but not exclusively, to permanent magnet machines, e.g. for driving elevator cabins or winches.

### SUMMARY

There exists a need to benefit from machines that provide high performance and that are compact in order to make it easier to install elevators, for example.

There exists a need to benefit from a machine that is relatively easy and inexpensive to manufacture, that operates reliably, and that is capable, where necessary, of providing a cabin safety or parachute function when used for driving an elevator cabin.

In one of its aspects, the present invention provides a rotary electric machine comprising:
a stator;
a rotor having an axis of rotation, and including a tubular end wall defining two opposite braking surfaces; and
an electromagnetic brake disposed, in a braking configuration, to bear simultaneously against the braking surfaces.

Advantageously, the braking surfaces present a diameter that is equal to or close to the greatest diameter of the rotor, e.g. to within 20%, or better to within 10%.

This makes it possible to benefit from relatively high braking torque.

The braking surfaces extend not entirely perpendicularly to the axis of rotation and may, for example, be substantially circularly cylindrical about the axis of rotation.

The rotor may include permanent magnets.

Applying braking to two opposite braking surfaces that rotate with the rotor makes it possible, when said surfaces are defined by a tubular wall of the rotor on which magnets are secured, to avoid ovalizing the wall and thus to avoid damaging the rotor. When magnets are bonded to the above-mentioned wall by adhesive, this reduces the risk of the magnets coming unstuck.

The rotor may be an outer rotor.

The rotor may define at least one drive surface for driving at least one cable. The drive surface is defined by a drive portion of the rotor.

In an exemplary embodiment of the invention, the drive portion may be provided with at least one annular groove for driving at least one cable. In a variant, the drive portion may be designed to receive a pulley.

The term “cable” should not be understood narrowly, and covers filamentary elements of all sections and structures, e.g. made of composite materials.

Where appropriate, the drive portion could have a single groove receiving only a single cable.

The drive portion is driven without gearing, thereby increasing the liability and possibly reducing operating noise, simplifying manufacture, and reducing overall size.

The machine may be arranged to transmit torque between the drive surface and the braking surface(s) via a single piece or via a plurality of pieces, but without torque being taken up by a mechanical assembly other than welding between the pieces.

Torque transmission is advantageously provided by a single piece constituting the rotor.

The rotor may include an end portion defining two opposite braking surfaces, which may be circularly cylindrical about the axis of rotation.

The stator may have a concentrated winding. In a variant, the winding of the stator could be distributed.

The rotor need not have any magnetic laminations.

The stator may include an inner support wall, e.g. of tubular shape extending at least in part between the windings of the stator and a shaft of the rotor.

The machine may include an encoder inside the above-mentioned support wall.

The machine may have two or more electromagnetic brakes, for example the brakes may be diametrically opposite.

The or each brake may have two brake pads suitable for bearing against the braking surfaces, each brake pad advantageously being curved and shaped to match the curvature of the corresponding braking surface.

The or each brake may include at least one jaw sliding on at least one guide rod.

The or each jaw may slide on at least two parallel guide rods.

The or each guide rod may extend substantially parallel to a plane perpendicular to the axis of rotation and may be oriented substantially horizontally.

The or each brake may include an electromagnet coil positioned radially inside the braking surface(s), thereby contributing to making the machine more compact.

In one of its aspects, the invention also provides a method of driving an elevator cabin, comprising using an electric machine as defined above to drive at least one cable connected to the cabin.

In another of its aspect, the invention also provides an electromagnetic brake having two opposite brake pads each having a braking face that is not plane, e.g. that is cylindrical.

In a braking configuration, these two opposite pads are designed to clamp onto a circularly cylindrical wall, for example.

The brake may have two jaws carrying pads and sliding on two parallel guide rods.

In another of its aspects, independently or in combination with the above, the invention also provides an electric machine comprising:
an outer rotor having a shaft and defining a drive surface for driving at least one cable;
at least one brake; and
a stator with windings situated axially between the brake and the drive surface.

Such a disposition of the brake(s) makes it easier to provide a machine that is compact.

### BRIEF DESCRIPTION OF THE DRAWINGS

The invention can be better understood on reading the following detailed description of non-limiting embodiments thereof, and on examining the accompanying drawings, in which:

FIG. 1 is a perspective view of an example machine made in accordance with the invention;

FIG. 2 is a diagrammatic longitudinal section of the FIG. 1 machine;

FIG. 3 is a cross-section on III-III of FIG. 2;

FIG. 4 is a diagrammatic and fragmentary view of the stator and the chassis of the machine;

FIG. 5 is a view analogous to FIG. 4, after a brake has been mounted thereon;

FIG. 6 is a view analogous to FIG. 4 without the guide rods and without the magnetic circuit of the stator;

FIG. 7 is a diagrammatic and fragmentary view of a brake shown in isolation and in perspective;

FIG. 8 is a diagrammatic and fragmentary axial section view of another example machine made in accordance with the invention;

FIG. 9 is a perspective view showing a variant example brake in perspective;

FIG. 10 is a section of the FIG. 9 brake on X-X of FIG. 11; and

FIG. 11 is a section on XI-XI of FIG. 10.

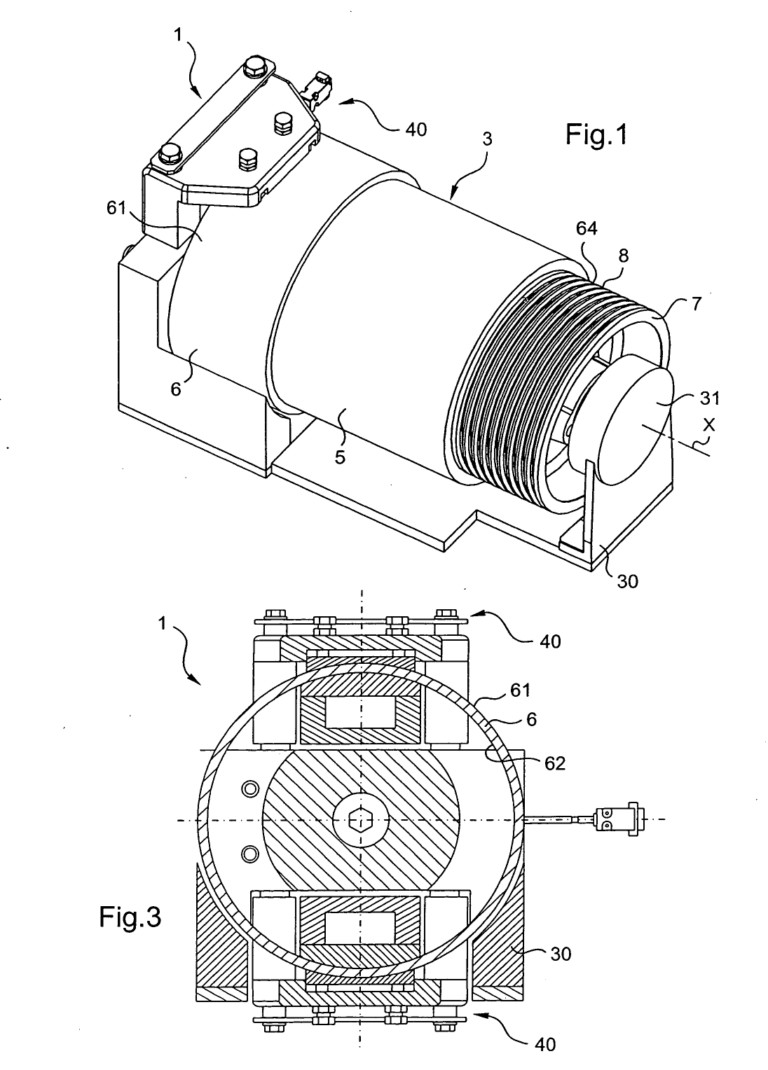

### MORE DETAILED DESCRIPTION

The electric machine 1 shown in the figures comprises a stator 2 and a rotor 3 capable of rotating about an axis of rotation X.

In the example described, the stator 2 has a concentrated winding, comprising teeth 26, each of which carries an individual coil 21.

The rotor 3 has permanent magnets 60 disposed to interact magnetically with the stator.

The magnets 60 are placed on the radially-inner surface of a tubular wall 5 of the rotor, which wall has at one end a portion 6 defining two braking surfaces 61 and 62, respectively a radially outer surface and a radially inner surface.

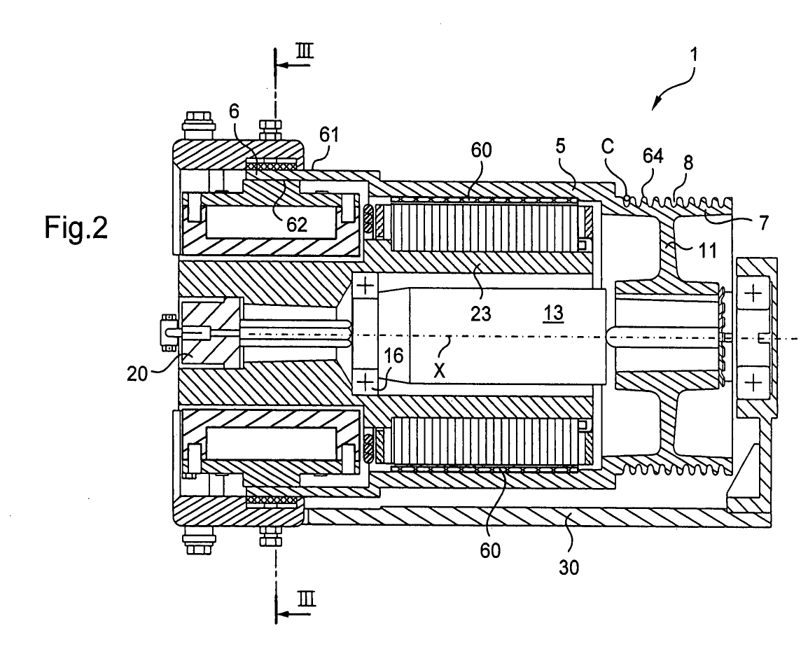

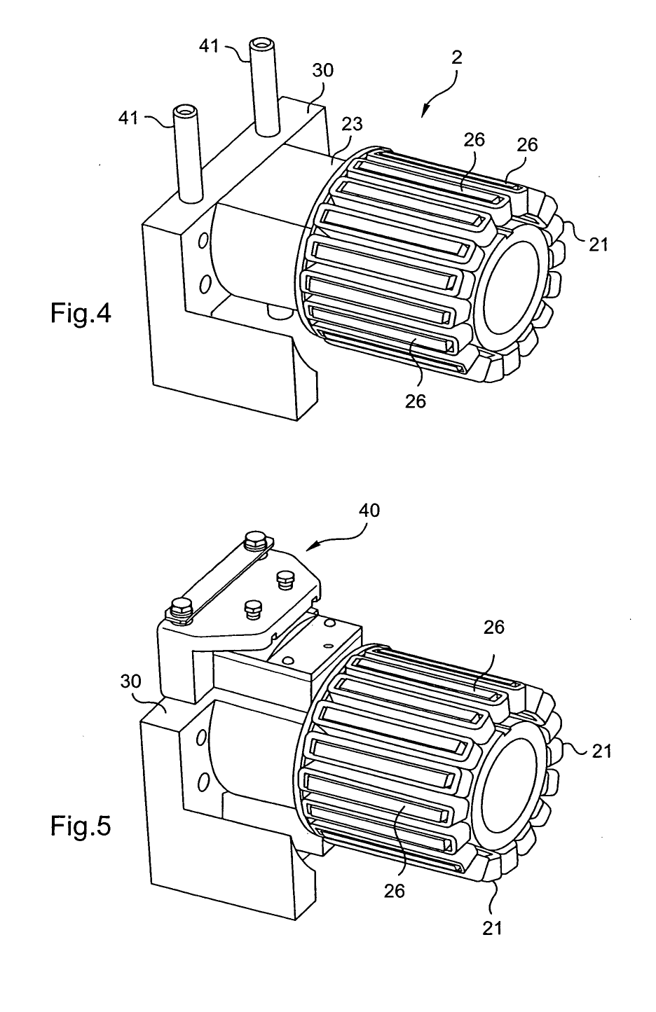

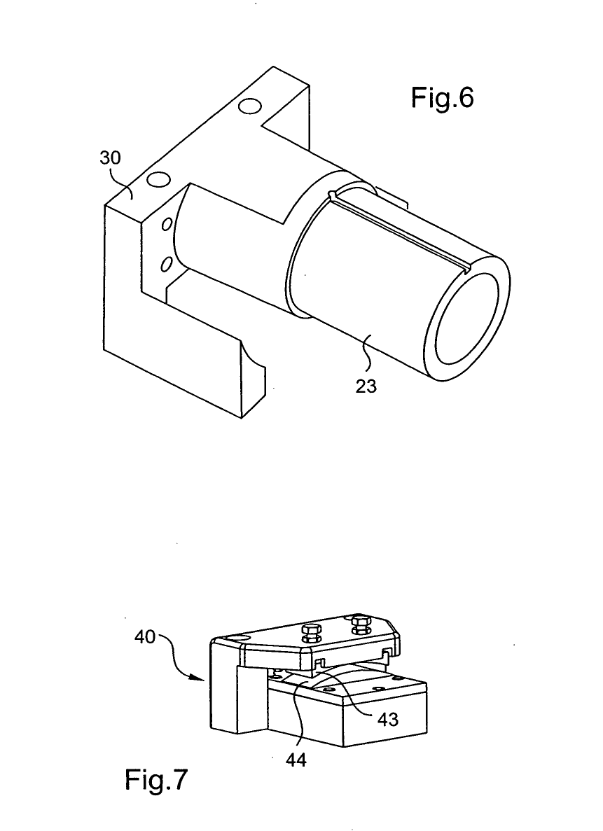

The wall 5 has a drive portion 7 at its other end that defines a drive surface 64 and that is provided in the example described with a plurality of grooves 8, each serving to receive a cable C, with only one cable being shown in section in FIG. 2 in order to clarify the drawing.

In the example shown, the tubular wall 5 is made as a single piece with the braking surfaces 61, 62 and the drive surface 64, e.g. by casting material and/or by machining, but in a variant that is not shown the drive portion 7 could be made as a first piece and the end portion 6 could be made as another piece, the pieces being connected together, preferably by welding.

The drive portion 7 in the example described is connected to a hub 10 by a transverse wall 11, which wall is possibly perforated in order to establish a flow of air.

The hub 10 is secured on a rotor shaft 13, e.g. via a connection using at least one key.

The ends of the shaft 13 are supported by bearings 16 and 17.

In the example shown, the machine 1 includes an encoder 20 for detecting rotation of the shaft 13.

The teeth 26 of the stator are connected to a yoke which is carried by an inner support wall 23 of the stator, of tubular shape about the axis X.

This support wall 23 extends away from the hub 10 beyond the coils 21 to be connected to a chassis 30 of the machine 1.

The bearing 16 is supported by the support wall 23, and the bearing 17 by an upright 31 of the chassis 30 at one end of the machine.

In the example described, at its end remote from the bearing 17, the machine 1 has at least one electromagnetic brake 40, and specifically two diametrically-opposite brakes 40, each disposed to bear against both of the bearing surfaces 61 and 62 in a braking configuration.

Each brake 40 is mounted on two guide rods 41 that are stationary relative to the chassis 30, and in the example described these rods have axes that are contained in a plane perpendicular to the axis of rotation X, e.g. extending horizontally when the machine is installed. When the guide rods 41 are not horizontal, the brakes may, in particular, include springs for compensating the weight of their jaws.

Each brake 40 comprises an electromagnet coil (not shown) and two jaws that, in the absence of the electromagnet coil being excited, are urged towards each other by one or more return springs (not shown).

The jaws carry respective pads 43 and 44 that can be seen in FIG. 7 in particular, that are arranged to press respectively against the braking surfaces 61 and 62.

So long as the electromagnet coil is powered electrically, the brake is not in its braking configuration and the end portion 6 can rotate freely.

When the electromagnet coil ceases to be powered electrically, the pads 43 and 44 press against the braking surfaces 61 and 62.

The pads 43 and 44 are curved so as to match the shape of the corresponding facing braking surface.

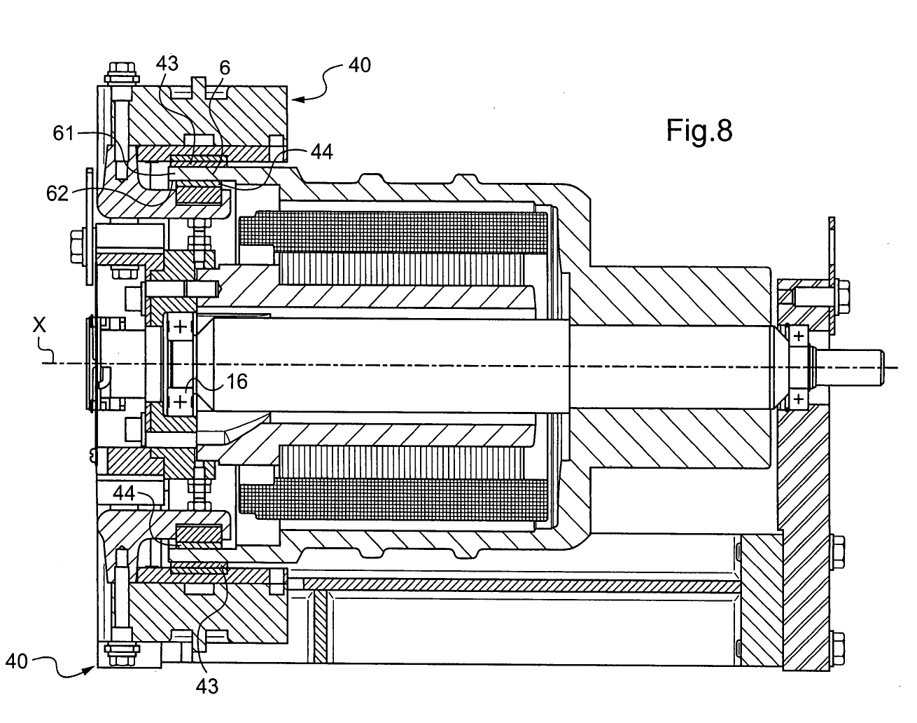

FIG. 8 is a diagrammatic and fragmentary axial section showing another example machine of the invention. The same reference symbols are used to designate elements that are identical or similar to those of the machine shown in FIG. 2.

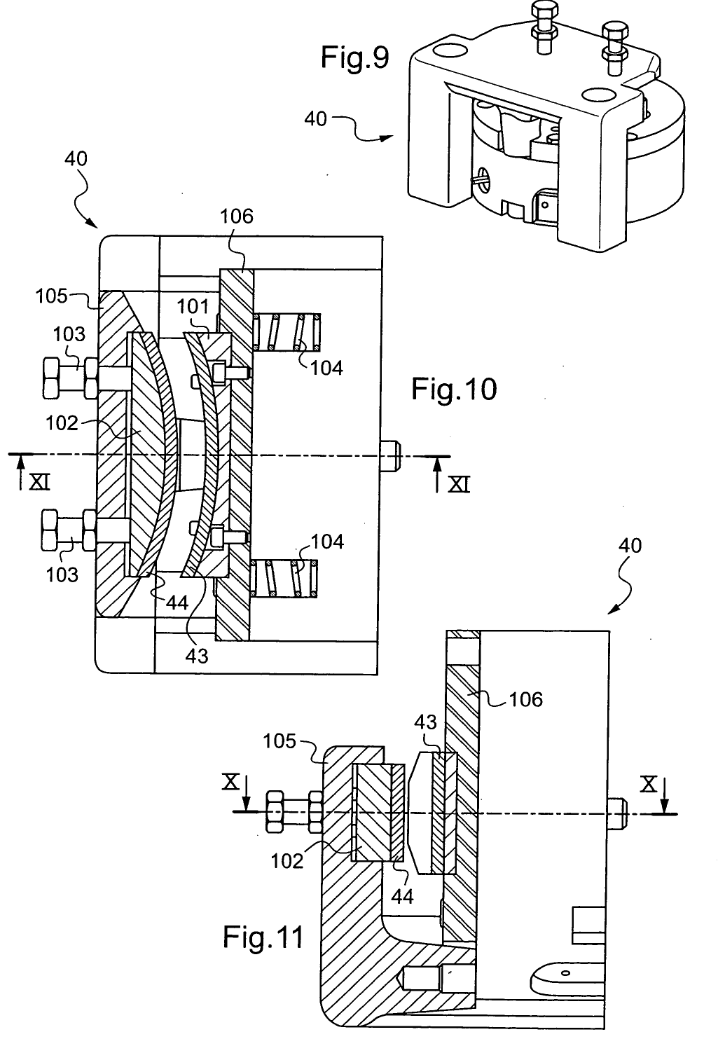

FIGS. 9 to 11 show in isolation one of the two brakes 40 fitted to this machine. It can be seen in these figures that the pads 43 and 44 are carried by respective supports 101 and 102. The support 102 enables clearance to be adjusted by means of a screw 103 engaging the corresponding jaw. Return springs 104 are provided to urge the jaws 105 and 106 towards each other in the absence of the electromagnet coil(s) being excited.

The invention is not limited to the embodiments described above.

In the example shown, the stator coils are disposed axially between the braking surfaces and the drive surface.

In a variant embodiment (not shown), the braking and drive surfaces are situated at the same end of the stator coils, the drive surface being disposed between the coils of the stator and the braking surfaces, for example.

The braking surfaces need not necessarily be cylindrical, for example they could be conical, biconical, or frustoconical, of axis that coincides with the axis of rotation.

In another variant that is not shown, the machine has at least one brake at one end of the stator coils and another brake at the other end of the stator coils, beside the drive portion 7.

The invention also applies to a machine having an inner rotor, with the braking surface then being defined, for example, by an extension of the tubular wall 5 adjacent to the drive portion 7.

The machine could have a single brake or it could have more than two brakes.

In the examples shown, each brake has one electromagnet coil, however it would not go beyond the ambit of the present invention for the machine to have a brake with more than one electromagnet coil, for example each coil could be associated with a respective single brake pad. At rest, the brake pads associated with each coil can bear against opposite braking surfaces, and when the coils are powered electrically, the corresponding brake pads move away from the braking surfaces.

The term “comprising a” should be understood as being synonymous with “comprising at least one” unless specified to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A rotary electric machine comprising:
a stator;
a rotor having an axis of rotation, and comprising a tubular end wall defining two opposite braking surfaces; and
at least one electromagnetic brake configured for bearing simultaneously in a braking configuration against the braking surfaces.

2. A machine according to claim 1, in which the braking surfaces are cylindrical surfaces of revolution about the axis of rotation.

3. A machine according to claim 1, in which the rotor has permanent magnets.

4. A machine according to claim 1, in which the rotor is an outer rotor.

5. A machine according to claim 1, in which the rotor defines at least one drive surface for driving at least one cable.

6. A machine according to claim 5, in which the drive surface includes at least one annular groove.

7. A machine according to claim 6, in which the drive surface has a plurality of annular grooves.

8. A machine according to claim 5, configured to transmit torque between the drive surface and the braking surfaces without torque being taken up by a mechanical assembly other than welding.

9. A machine according to claim 8, in which torque is transmitted by a single one-piece rotor.

10. A machine according to claim 1, in which the stator is a concentrated winding stator.

11. A machine according to claim 1, in which the stator comprises a support wall extending at least in part between stator coils and a shaft of the rotor.

12. A machine according to claim 11, comprising an encoder disposed inside the support wall.

13. A machine according to claim 1, comprising two electromagnet brakes.

14. A machine according to claim 13, in which the brakes are diametrically opposite.

15. A machine according to claim 1, in which the at least one electromechanical brake comprises two brake pads suitable for bearing against the braking surfaces.

16. A machine according to claim 15, in which each brake pad is curved to have a shape matching a curvature of the corresponding braking surface.

17. A machine according to claim 1, in which each brake has at least one jaw mounted to slide on at least one guide rod.

18. A machine according to claim 17, in which each jaw slides on at least two parallel guide rods.

19. A machine according to claim 17, in which the guide rods extend substantially parallel to a plane perpendicular to the axis of rotation.

20. A machine according to claim 17, in which the guide rods extend substantially horizontally.

21. A machine according to claim 1, in which the at least one brake comprises an electromagnet coil positioned radially inside the braking surfaces.

22. A machine according to claim 1, in which the at least one brake comprises a screw for adjusting the spacing between the brake pads and the braking surfaces in the absence of braking.

23. A method of driving an elevator cabin, comprising using an electric machine as defined in claim 1 to drive at least one cable connected to the cabin.

24. An electromagnetic brake for fitting to a machine as defined in claim 1, the brake comprising two moving brake pads, each presenting a braking face that is not plane.

25. A brake according to claim 24, the braking face being cylindrical.
